(19) United States
(12) Patent Application Publication
(10) Pub. No.: US 2020/0111043 A1
(43) Pub. Date: Apr. 9, 2020

(54) SYSTEM AND METHOD FOR PROVIDING PERSONALIZED PLANNING

(71) Applicant: Milan Cheeks, Moriches, NY (US)

(72) Inventor: Milan Cheeks, Moriches, NY (US)

(21) Appl. No.: 16/151,409

(22) Filed: Oct. 4, 2018

(51) Int. Cl. G06Q 10/06; G06N 5/02; G06K 7/14

(52) U.S. Cl. CPC G06Q 10/063112; G06K 7/1413; G06N 5/02

(57) ABSTRACT

A personalized planning system is disclosed. The personalized planning system has a personalized planning module, comprising computer-executable code stored in non-volatile memory, a processor, and a user interface. The personalized planning module, the processor, and the user interface are configured to prompt a user to provide input data that includes biographical information and at least one user goal, use artificial intelligence to analyze the input data, and provide output data via the user interface based on using artificial intelligence to analyze the input data. The output data includes a user-specific customized plan. The user-specific customized plan includes a plurality of tasks. Completion of the plurality of tasks by a user results in completion of the at least one user goal.

### FIELD OF THE INVENTION

The present invention generally relates to a system and method for providing personalized planning. For example, embodiments of the present invention are directed to providing personalized planning including a customized plan for a user.

### BACKGROUND

Conventional approaches for helping individuals attain goals typically involve generic products and activities such as self-help books, motivational speakers, and generic seminars that provide general information to consumers. For example, conventional approaches for helping individuals attain goals usually provide generic advice such as advice for a user to stay motivated, organized, and committed to a goal.

Accordingly, conventional approaches typically do not involve tailored approaches that are customized to users based on user-specific information. Also, for example, conventional approaches do not provide user-specific analysis to provide unique steps that a specific user may follow to achieve user-specific goals.

The exemplary disclosed system and method of the present disclosure is directed to overcoming one or more of the shortcomings set forth above and/or other deficiencies in existing technology.

### SUMMARY OF THE DISCLOSURE

In one exemplary aspect, the present disclosure is directed to a personalized planning system. The personalized planning system includes a personalized planning module, comprising computer-executable code stored in non-volatile memory, a processor, and a user interface. The personalized planning module, the processor, and the user interface are configured to prompt a user to provide input data that includes biographical information and at least one user goal, use artificial intelligence to analyze the input data, and provide output data via the user interface based on using artificial intelligence to analyze the input data. The output data includes a user-specific customized plan. The user-specific customized plan includes a plurality of tasks. Completion of the plurality of tasks by a user results in completion of the at least one user goal.

In another aspect, the present disclosure is directed to a method. The method includes prompting a user to provide input data that includes biographical information and at least one user goal, using artificial intelligence to analyze the input data, providing output data via the user interface based on using artificial intelligence to analyze the input data, and sensing location data of a user. The output data includes a user-specific customized plan. The user-specific customized plan includes a plurality of sequenced tasks. Completion of the plurality of sequenced tasks by the user results in completion of the at least one user goal.

### BRIEF DESCRIPTION OF THE DRAWINGS

FIG. 1 is a schematic illustration of at least some exemplary embodiments of the present disclosure;

FIG. 2 illustrates an exemplary process flow of at least some exemplary embodiments of the present disclosure;

FIG. 3 illustrates a schematic illustration of at least some exemplary embodiments of the present disclosure;

FIG. 4 illustrates an exemplary process flow of at least some exemplary embodiments of the present disclosure;

FIG. 5 is a schematic illustration of an exemplary computing device, in accordance with at least some exemplary embodiments of the present disclosure;

FIG. 6 is a schematic illustration of an exemplary network, in accordance with at least some exemplary embodiments of the present disclosure; and

FIG. 7 is a schematic illustration of an exemplary network, in accordance with at least some exemplary embodiments of the present disclosure.

### DETAILED DESCRIPTION AND INDUSTRIAL APPLICABILITY

In at least some exemplary embodiments, the exemplary disclosed system and method may provide a personal enhancement application that may help guide users to their goals. For example, the exemplary disclosed system and method may be a mobile application that may be used on a mobile platform such as a mobile smartphone or tablet, a desktop or laptop, and/or any desired computing device. The exemplary disclosed system and method may be a system for providing a holistic approach to attaining goals. For example, the exemplary disclosed system and method may help users to attain realization of life goals and a desired lifestyle.

In at least some exemplary embodiments, the exemplary disclosed system and method may recommend tools, tasks, and/or educational courses to help a user be successful in professional and/or personal fields of endeavor. For example, if a given user would like to become a successful clothes designer or build a successful social media business, the exemplary system may create a “to do” list of courses and tasks the user may perform to achieve such a desired goal. As described for example herein, the exemplary disclosed system and method may record and analyze user behavior involving any suitable user attributes (e.g., behavior, food-choice, diet and/or any other suitable attribute). For example, if a user is on a certain diet (e.g., a no-carb diet, a non-gluten diet, a Mediterranean diet, and/or any other type of diet) and would like to go out to eat, the system may use the exemplary geo-location feature described further below to determine and recommend items the user may like to order at inputted and/or recommended locations. The exemplary disclosed system and method may include other exemplary features as described for example below.

In at least some exemplary embodiments, the exemplary disclosed system and method may be presented in a social media format to users. Users may be able to follow, like, comment, and/or join activities (e.g., plans) of other users. The exemplary disclosed system and method may also provide a networking (e.g., social and/or professional networking) environment, and may for example provide one-on-one and/or group conferences.

In at least some exemplary embodiments, the exemplary disclosed system may ask specific questions (e.g., prompt users with questions) and search (e.g., look out) for specific keywords and any other suitable criteria for creating a custom plan (e.g., plan customized to user). The plan may include one or more tasks (e.g., stages, steps, and/or goals). A user (e.g., consumer) may be tracked and guided through a plurality of stages or steps of a plan with reminders. Each stage or step may be broken down into small goals, and the user or consumer may be rewarded for each stage or step completion (e.g., and/or each goal completion). Rewards may vary from system course credits, currency (e.g., U.S. Dollars, other national currency, cryptocurrency, and/or any other desired currency), system coins (e.g., Self Coins) or points, and/or any other suitable credits or rewards.

In at least some exemplary embodiments, the exemplary disclosed system may operate partially or substantially entirely utilizing Artificial Intelligence and/or any other suitable technique for learning actions and/or behaviors of users (e.g., single users and/or aggregate behaviors of sets of users) and using this exemplary learning to personalize or customize activity plans and/or goal plans for users. For example, the exemplary disclosed system may ask questions and use answers and input from users to identify keywords and/or use image recognition to identify a given user and/or user environment.

In at least some exemplary embodiments, the exemplary disclosed system may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

In at least some exemplary embodiments, the exemplary disclosed system and method may include features such as a fitness tracker, a geo-location feature, a map feature, a near-field communication (e.g., NFC) feature, barcodes such as matrix barcodes or two-dimensional barcodes (e.g., and barcode scanners), Bluetooth features such as Bluetooth low energy beacons, and/or Blockchain features as disclosed for example herein. The exemplary disclosed system and method may include online, live, and/or pre-recorded educational and fitness classes, life and relationship coaching, meditation practices, a goal tracker (e.g., feature for providing a status of a user's plan, stages or steps, and/or goals), and/or any other suitable feature.

In at least some exemplary embodiments, the exemplary disclosed system and method may include a fitness tracker module, apparatus, and/or function that may monitor and track a user's performance in one or more categories or areas. For example, the fitness tracker may track a user's activities such as food intake, supplement intake, medicine intake, physical activity and exercise, and/or any other suitable fitness-related and/or health-related activity (e.g., and may provide output such as diagrams, charts, and other visualization tools that may illustrate the exemplary areas of fitness tracking). For example, if a user is an athlete or a body builder, that user may use the exemplary disclosed system and method to track a percentage use of a specific body part. For example, if the user worked out his or her biceps, the exemplary disclosed system may gauge stress and/or growth that body part experience. In at least some exemplary embodiments, the exemplary disclosed system and method may include and/or communicate with one or more biometric devices and/or other sensors that may monitor any desired user attribute such as blood pressure, body temperature, pulse, movement, muscle gain, weight gain, and/or any other desired characteristic of a user. The exemplary disclosed system and method may track and record variance of any attribute tracked or measured by the system.

In at least some exemplary embodiments, the exemplary disclosed system and method may include a geo-location module, apparatus, and/or function that may be used for tracking and/or analyzing any suitable activity. The geo-location feature may include a global positioning system (GPS) device or other location sensor that may be located with the user (e.g., the geo-location feature may communicate with a location sensor such as a GPS device integrated into a user's smartphone or other user device). For example, the geo-location feature may be a dining or eat-out feature in which the exemplary disclosed system may recommend restaurants based on a user's location and/or proposed items to order at select restaurants (e.g., based on menus available on the internet, information crowd-sourced to the system by other users, and/or any other suitable source). For example, the exemplary disclosed system may recommend select healthy, beneficial, and/or desired dining options to a user.

Also for example, a user may be prompted by the exemplary disclosed system using the geo-location module to travel to a specific location (e.g., a location that may serve as a milestone location) to complete a goal (e.g., a goal that may be part of a stage or step). For example, if the user wants to become a real estate agent (e.g., or other professional or working activity), the exemplary system may guide the user to attend a class or seminar that may provide them with tailored or hands-on training to accomplish this exemplary customized plan. The exemplary system may also use the geolocation feature to track the user's location as confirmation (e.g., evidence or proof) that the user went to a given location.

Further for example, the exemplary disclosed system may use the geo-location feature to confirm a user's location and activities for the purpose of confirming goals, stages, and/or steps as complete and for providing rewards (e.g., system coins or other rewards). For example, the exemplary system may use the geo-location feature to confirm that a user physically went to a select location for a threshold period of time to help confirm that a goal, stage or step of a customized plan was completed (and the awarding of duplicate or inappropriate awards may be substantially prevented).

In at least some exemplary embodiments, the exemplary disclosed system and method may include a maps feature that may work in conjunction with a location sensor (e.g., the exemplary location sensor of the geo-location feature). The exemplary maps feature may help guide a user to a desired or predetermined location (e.g., a location that may be part of a goal, stage, and/or step of a user's plan). The exemplary system and maps feature may work in conjunction with any desired application (e.g., such as Google Maps Open API).

In at least some exemplary embodiments, the exemplary disclosed system and method may include a near field communication (NFC) feature and/or barcode (e.g., matrix barcodes such as QR, e.g., two-dimensional barcodes) feature. For example, the NFC feature and/or barcode feature may be used to sign in or register at different locations (e.g., as part of a customized or tailored plan). For example, a user may use a system pass (e.g., via a user device such as a smartphone) such as a self-pass and/or a barcode scanner to sign in at a given location. For example, the user may either use a pass to scan in with a scanner at a given location, or a scanner to scan a barcode at a given location. For example, the user may use the NFC feature and/or barcode feature to sign in at a location such as a gym. Also for example, users may use their smartphone or other user device (e.g., that may include or communicate with the system's NFC feature and/or barcode feature) to “bump” their device with a barcode or scanner at a given location. For example, a user may use a unique barcode (e.g., QR Code) to sign at a desired location (e.g., a gym or any other activities center). The feature may thereby operate as a key card. A similar operation may occur involving an exemplary NFC feature (e.g., if a user “bumps” their phone or other user device).

For example, a self-pass (e.g., “Self Pass”) of the exemplary system may be a universal gym pass that gives access to a user by the system to any fitness center (e.g., based on an operation of the NFC feature and/or barcode feature). The self-pass may provide access to gyms and/or other locations for activities such as yoga classes, spin classes, boxing classes, swimming classes, and/or any other desired classes. The exemplary self-pass may also offer access to other facilities for any desired activities (e.g., such as a library, senior center, youth center, community center, counseling center, and/or any other desired facility or location). For example, the exemplary self-pass may include a unique code that may be able to be read at each location based on existing (e.g., already in place) systems.

In at least some exemplary embodiments, the exemplary disclosed system and method may include offering fitness classes, fitness games, and/or other suitable classes in desired facilities (e.g., facilities accessible through the exemplary self-pass).

In at least some exemplary embodiments, the exemplary disclosed system and method may include a location-specific feature (e.g., a beacon feature that may be specific to one or more select locations). For example, the exemplary location-specific (e.g., beacon) feature may provide for rewards to users who are located (e.g., physically located) at a given location (e.g., during a predetermined time period). The location-specific feature may also send information regarding a select location such as, for example, new laws that may be in effect in a jurisdiction in which the select location is located.

In at least some exemplary embodiments, the exemplary disclosed system and method may include one or more educational features such as an online school and/or other educational content that may be reached by a user communicating via a user interface communicating with one or more exemplary system modules. For example, the exemplary system may offer classes to users (e.g., web-based or online classes) with experts or other professionals in given fields (e.g., based on a customized plan of a user). For example, the exemplary system may recommend educational content to a user (e.g., as a stage, step, or goal of a customized plan). The educational content may be reached via a user interface and/or at a physical location as described for example above (e.g., the geo-location feature may confirm physical attendance). For example, if a user would like to be a comedian, the system may recommend watching or attending an experienced and/or celebrity comedian who may be able to share advice based on that comedian's experiences (e.g., a comedian such as Kevin Hart could provide educational content to aspiring comedians). The exemplary system may also for example operate in conjunction with existing educational content providers such as educational organizations, universities, and/or for-profit educational providers. The educational features or modules of the exemplary system may provide users with a list of accredited courses to use to become certified in their desired field as part of a given user's customized plan. For example, courses may serve as stages, steps, or goals that a given user may accomplish as part of that user's customized plan. The exemplary system may for example recommend courses to a given user based on his or her customized plan. An exemplary course may for example be hosted in an application of the exemplary system or may direct the user to an online platform or physical location to continue the process for pursuing that user's customized plan. The exemplary system may also provide recommendations to utilize third party classes and/or other suitable content and may provide discount codes for purchase and/or other suitable promotional offers. For example, the exemplary system and method could be used for homeschooling of children, continuing education courses and programs such as GEDs, and pursuing college degrees.

In at least some exemplary embodiments, the exemplary disclosed system and method may include a therapy feature and may serve as a relationship and life coach. For example, users may use the exemplary system to consult with therapists in order to receive help in dealing with problems in their life. For example, the exemplary system and method may prevent users from feeling that they are alone or isolated, because the exemplary system may offer opportunities for therapy and consultation with professionals (e.g., users may contact therapists via an exemplary user interface based on an operation of the exemplary system).

In at least some exemplary embodiments, the exemplary disclosed system and method may include a mindfulness or meditation feature. For example, the exemplary disclosed system may provide instruction or substantive content that may help users to perform exercises or activities that promote mindfulness and/or that provide the user with the beneficial effects of practicing mindfulness or meditative activities. The exemplary system may also operate in conjunction with third party providers of mindfulness or meditative exercises to make additional content and material available to users. Mindfulness or meditative exercises and/or activities may also be offered by the exemplary system as portions of a customized user plan (e.g., as a stage, step, or goal).

In at least some exemplary embodiments, the exemplary disclosed system and method may include a cryptocurrency feature. For example, the exemplary system may include a blockchain feature that may provide a cryptocurrency feature (e.g., a system cryptocurrency or alt-coin). The exemplary system cryptocurrency or alt-coin may be specific to the exemplary system and may be given any suitable designation or name such as “self-coin.” The exemplary system may also utilize an existing cryptocurrency such as Bitcoin. For example, the exemplary system cryptocurrency or alt-coin may be provided to users as a reward for completing stages, steps, goals, or any other suitable portion of a customized plan. The exemplary system cryptocurrency or alt-coin may have a monetary value and may be traded publicly as a cryptocurrency. The exemplary system cryptocurrency or alt-coin may be used to purchase courses, subscriptions, and/or other system offerings via the exemplary system and method. Also for example, the cryptocurrency feature may provide for paid advertisements to be provided using the exemplary system.

In at least some exemplary embodiments, the exemplary disclosed system and method may include a personal information feature. The exemplary system may for example record, store, and provide resume information or other biographical information regarding a user. For example, the user may provide a system profile of that user to prospective employers, professional contacts, social contacts, and/or any other suitable (e.g., authorized) third party. For example, a user's system profile may serve as a resume for review by a prospective employer. Also for example, the exemplary system may store identification such as a driver license (e.g., a digital scan of identification such as a driver's license). The stored identification may for example be scanned via an NFC and/or barcode feature (e.g., and/or an optical recognition device) of the exemplary system and/or of a third party (e.g., to allow quick and simplified sign-in at a location). The personal information feature may record, store, and/or provide data regarding any suitable identification such as, for example, a driver's license, passport, certificate of citizenship, insurance information, birth certificate, veteran or military identification, and/or any other suitable form of identification.

In at least some exemplary embodiments, the exemplary disclosed system and method may include a jurisdiction feature. For example, the jurisdiction feature may update a user regarding any relevant legal changes in their jurisdiction. For example, the exemplary system may update users regarding changes to laws that are relevant to their customized plan (e.g., any stage, step, or goal). Also for example, the system may recommend changes and/or automatically change a user's customized plan (e.g., stage, step, or goal) based on changes to laws in a given jurisdiction. The exemplary jurisdiction feature may work in conjunction with the geo-location feature to identify relevant changes to laws in a given jurisdiction in which a user is physically located. For example, the exemplary system may substantially prevent a user from being unaware of relevant laws, ordinances, or other rules in a given jurisdiction. In at least some exemplary embodiments, the exemplary system may provide updates and/or alerts to users regarding laws affecting their respective customized plans and/or legal changes in given jurisdictions.

In at least some exemplary embodiments, the exemplary disclosed system and method may include a tracking feature (e.g., a stage, step, or goal tracking feature) that may track progress of a given user's customized plan. The tracking feature may confirm whether stages, steps, or goals of a plan have been completed, and may be validated or confirmed by system administrators (e.g., using a customizer relationship management module) and/or the exemplary geo-location feature to confirm physical location when relevant to a given stage, step, or goal. For example, stages, steps, goals, or other portions of a customized plan may be verified (e.g., by system administrators or automatically based on operation of the exemplary system) within a predetermined period of time (e.g., within 24 hours).

In at least some exemplary embodiments, some or all of the exemplary features described herein may be provided by an exemplary module of the exemplary system as described herein. The exemplary features may for example be provided by, integrated into, and/or include components of the exemplary modules, processors, computing devices, artificial intelligence components, user interfaces, and/or any other suitable system component. For example, a user may enter input and receive output regarding operation of the exemplary features via a computing device or user interface as described herein.

In at least some exemplary embodiments, the exemplary system and method may include holistic analysis features. For example, the exemplary system and method may utilize holistic information such as natal charts, numerology information, and psychology models and templates to analyze, identify, and/or group users. For example, the exemplary system and method may provide a technique for giving a substantially complete description (e.g., holistic description) of users. For example, the exemplary system may classify or group (e.g., break down user or consumer information) users into any suitable category (e.g., any category recognized in society to which some or many individuals deem valid) such as psychological or personality trait groups (e.g., the “Big 5” personality traits), astrological category or sign, numerological groupings, and/or any other suitable type of grouping. For example, holistic information such as personality or psychological information, astrological information, numerology information, horoscope information, and/or any other suitable type of information or groupings that have a societal following or recognition may be used by the exemplary system to analyze a user to for example develop a customized plan (e.g., having a plurality of stages, steps, and/or goals). For example the exemplary system may utilize artificial analysis as described for example herein.

In at least some exemplary embodiments, the exemplary system and method may provide information that may be of value to a given user based on the system's analysis, the user's customized plan provided by the system, and/or user input. For example, the exemplary system may provide a daily digest of recommendation for a client to improve (e.g., complete or prepare to complete stages, steps, and/or goals) and/or any other information that may be valuable to a user in attaining goals (e.g., such as holistic information such as horoscope information).

In at least some exemplary embodiments, the exemplary system and method may provide a user score. The user score may include any desired label, name, or designation such as, for example, “self score.” The exemplary user score may be based for example on a user's behavior, tracked actions and activities, input, and/or social interaction (e.g., as recorded and scored by the system). A user may have an option (e.g., based on entering input to the system) to use this function or to turn off the exemplary function. In at least some exemplary embodiments, the user may utilize the user score to help obtain expedited hotel check-ins, TSA Precheck, and/or in any other suitable activity in which the user score may be relevant or helpful.

In at least some exemplary embodiments, the exemplary system and method may involve onboarding experts (e.g., automatically onboarding experts) in desired fields and/or obtaining relevant licenses (e.g., as identified by an exemplary operation of the system). For example, the exemplary system may include licensing information for operating in conjunction with third party systems (e.g., system such as gyms, fitness class providers, cross-fit providers, trainers, state government officials, insurance companies, hotels, web platforms and services, and/or any other suitable provider.

In at least some exemplary embodiments, the exemplary system and method may recommend activities to a user based on an analysis of available user information. For example, the exemplary system may recommend activity locations, travel destinations, products or services to purchase, charities or volunteer work to participate in, and/or any other suitable recommendations. The exemplary recommendations may be made part of a user's customized plan (e.g., form some or all of a given stage, step, or goal). The exemplary system may similarly use the above information to provide rewards to a user (e.g., reward the user with items the user may favor based on the system's analysis such as select vacations, movie tickets, amusement parks, and/or other suitable rewards).

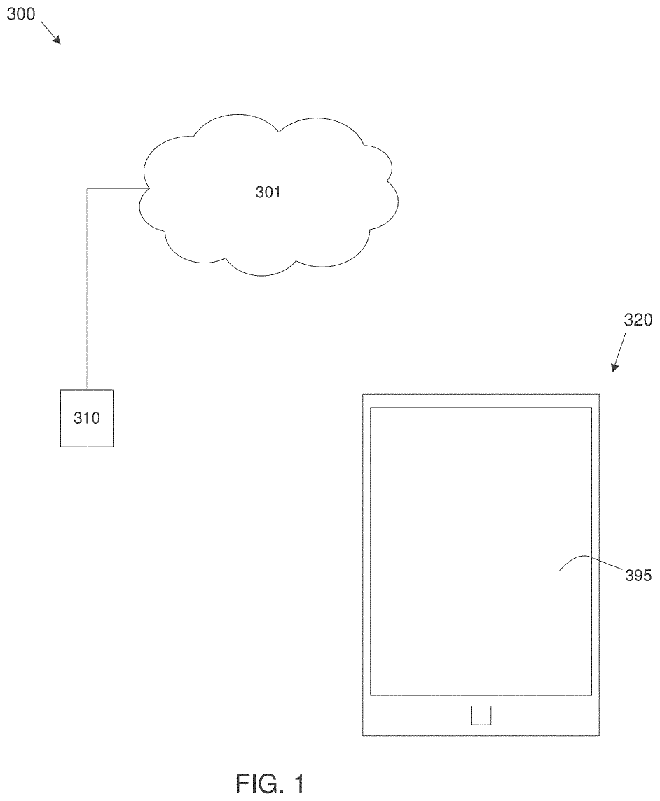

As illustrated in FIG. 1, system 300 may include a module 310 and a user interface 320. System 300 may include a plurality of user interfaces 320. Module 310 and user interface 320 may be connected for example via network 301, which may be similar to the exemplary networks disclosed below. Module 310 may include one or more of the exemplary features and/or modules described herein.

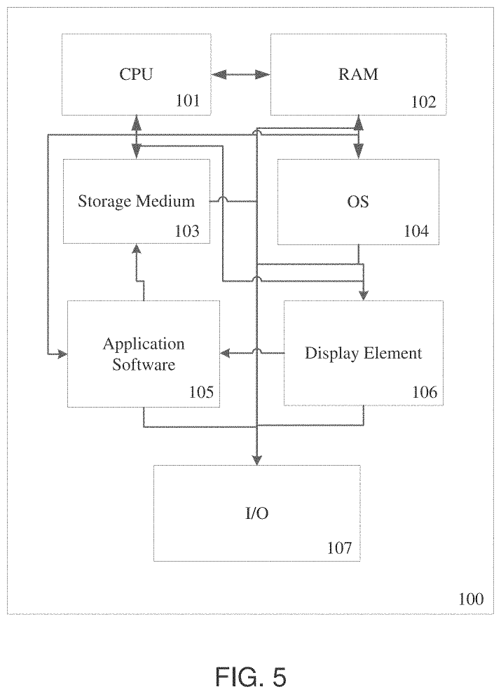

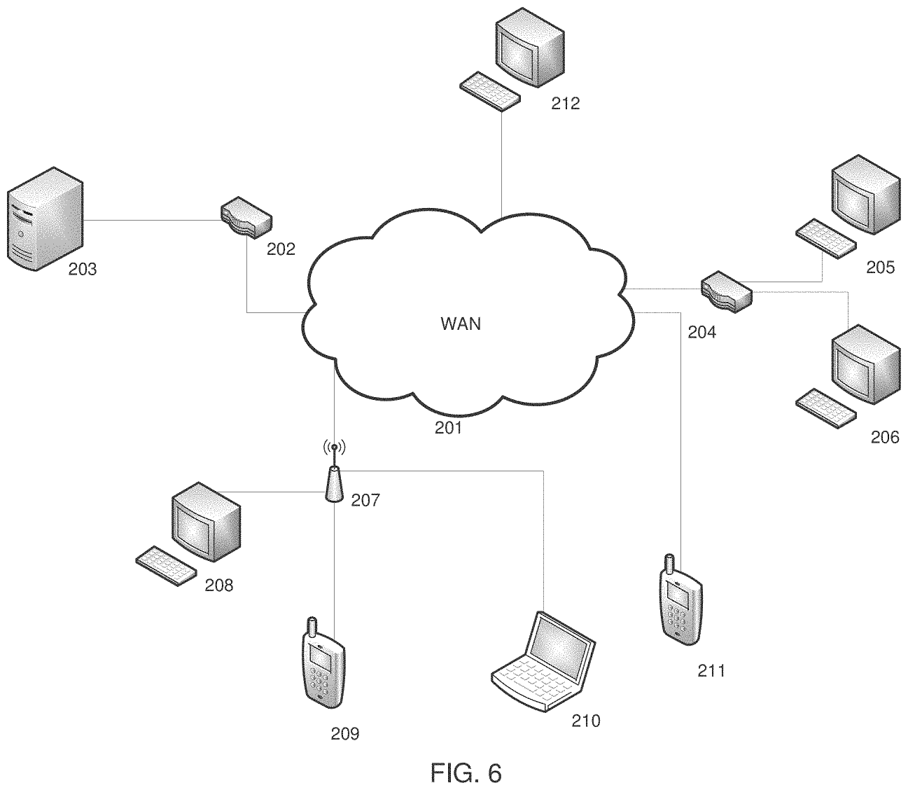

Module 310 may communicate with other components of system 300 via network 301 (e.g., as disclosed below). Module 310 may also be partially or substantially entirely integrated with one or more components of system 300 such as, for example, network 301 and/or user interface 320. Module 310 may include components similar to the exemplary components disclosed below regarding FIGS. 5 and 6. For example, module 310 may include computer-executable code stored in non-volatile memory. Module 310 may also include a processor, or alternatively, a processor for processing data associated with system 300 may be partially or substantially entirely integrated into any portion (e.g., or combination of portions) of system 300 (e.g., network 301 and/or one or more user interfaces 320).

Module 310 may be configured to retrieve, store, process, and/or analyze data transmitted to and/or from one or more user interfaces 320. For example, module 310 may operate using data from any desired number of user interfaces 320 such as, for example, one, two, several, dozens, hundreds, and/or thousands or more user interfaces 320.

Module 310 may perform analysis (e.g., including artificial intelligence analysis as described herein) using the data received from one or more user interfaces 320. For example, personal communication module 310 may utilize sophisticated machine learning and/or artificial intelligence techniques to perform predictive analysis using some or substantially all data collected by one or more user interfaces 320. For example, system 300 (e.g., module 310) may for example utilize the collected data to prepare and submit (e.g., via network 301, for example via wireless transmission such as via 4G LTE networks) datasets and variables to cloud computing clusters and/or other analytical tools (e.g., predictive analytical tools) which may analyze such data using artificial intelligence neural networks. Module 310 may for example include cloud computing clusters performing predictive analysis. For example, personal communication module 310 may utilize neural network-based artificial intelligence.

User interface 320 may be any suitable user interface for receiving input and/or providing output (e.g., raw data and/or results of predictive analysis described above) to a user. For example, user interface may be, for example, a touchscreen device (e.g., of a smartphone, a tablet, a smartboard, and/or any suitable computer device), a computer keyboard and monitor (e.g., desktop or laptop), an audio-based device for entering input and/or receiving output via sound, a tactile-based device for entering input and receiving output based on touch or feel, a dedicated user interface designed to work specifically with other components of system 300, and/or any other suitable user interface (e.g., including components and/or configured to work with components described below regarding FIGS. 5 and 6). For example, user interface 320 may include a touchscreen device of a smartphone or handheld tablet. For example, user interface 320 may include a display 395 (e.g., a computing device display, a touchscreen display, and/or any other suitable type of display) that may provide raw data and/or predictive analysis results to a user. For example, display 395 may include a graphical user interface to facilitate entry of input by a user and/or receiving output. For example, a user may utilize user interface 320 to query raw data results and/or enter parameters to define a set of desired output. Also for example, system 300 may provide notifications to a user via output transmitted to user interface 320. System 300 may also send such notifications by alternative methods such as, for example, via text message, email, and/or recording sent by telephone.

In at least some exemplary embodiments, the exemplary disclosed system may include a personalized planning module, comprising computer-executable code stored in non-volatile memory, a processor, and a user interface. The personalized planning module, the processor, and the user interface may be configured to prompt a user to provide input data that includes biographical information and at least one user goal, use artificial intelligence to analyze the input data, and provide output data via the user interface based on using artificial intelligence to analyze the input data. The output data may include a user-specific customized plan. The user-specific customized plan may include a plurality of tasks. Completion of the plurality of tasks by a user may result in completion of the at least one user goal. The user interface may include a location sensor. Providing output data may include using location data sensed by the location sensor to provide output data selected from the group consisting of legal information of a jurisdiction, dining location and menu information, and directions to one or more locations. The plurality of tasks may be a plurality of sequenced tasks. Using artificial intelligence to analyze the input data may include identifying keywords in the input data. Using artificial intelligence to analyze the input data may include learning actions and behaviors of system users. Learning actions and behaviors of system users may include learning aggregate behaviors of sets of users. The personalized planning module, the processor, and the user interface may be configured to output data via the user interface of which of the plurality of tasks is complete and which of the plurality of tasks is incomplete. Outputting data via the user interface of which of the plurality of tasks is complete and which of the plurality of tasks is incomplete may include using location data provided by the user interface. The personalized planning module, the processor, and the user interface may be configured to output data via the user interface including information selected from the group consisting of a user fitness status, a user nutritional status, educational course information, and personal identification information. The input data and the output data may include cryptocurrency data.

In at least some exemplary embodiments, the exemplary disclosed system may include a personalized planning module, comprising computer-executable code stored in non-volatile memory, a processor, and a location sensor. The personalized planning module, the processor, and the location sensor may be configured to prompt a user to provide input data that includes biographical information and at least one user goal, use artificial intelligence to analyze the input data, and provide output data via the user interface based on using artificial intelligence to analyze the input data. The output data may include a user-specific customized plan. The user-specific customized plan may include a plurality of sequenced tasks. Completion of the plurality of sequenced tasks by a user may result in completion of the at least one user goal. The completion of at least one of the plurality of sequenced tasks may be confirmed using a sensed location of the user based on data sensed by the location sensor. The personalized planning module, the processor, and the location sensor may be configured to output user fitness status data via the user interface. The exemplary disclosed system may further include a biometric sensor that senses biometric data, wherein the user fitness status data is based on the biometric data. The exemplary disclosed system may further include a sign-in device selected from the group consisting of a near field communication device and a barcode scanning device.

The exemplary disclosed system and method may be used in any application involving customized personal planning. For example, the exemplary disclosed system and method may be used in any suitable application for providing a customized plan for users to achieve personal goals. For example, the exemplary disclosed system and method may be used for any suitable application for achieving personal, professional, social, spiritual, education, and/or any other desired goals.

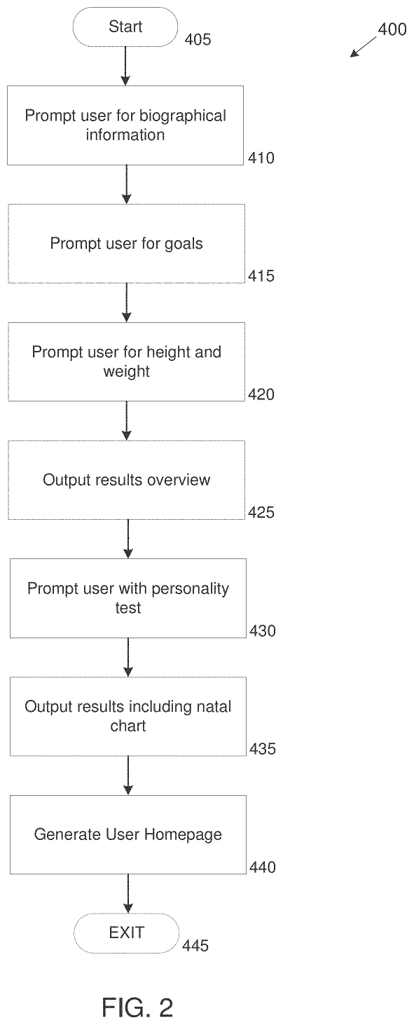

An exemplary operation of the exemplary disclosed system and method will now be described. For example, FIG. 2 illustrates an exemplary process 400 for generating a user profile and homepage (e.g., a user-specific homepage). Process 400 starts at step 405. At step 410, the exemplary system may prompt a user to enter biographical information. For example, the exemplary system may prompt a user to enter the user's name, email, password, birthday, birth time of day, birthplace, favorite things to do (e.g., from a list or pulldown including suggestions such as movies, amusement parks, and concerts), and/or any other biographical information.

At step 415, the system may prompt the user to enter short-term goals and long-term goals. The user input regarding these goals may be analyzed for example using the exemplary artificial intelligence processes described herein.

At step 420, the system may prompt the user to enter height and/or weight information. For example, the system may prompt the user to enter an actual weight, a desired or target weight, and/or a user height. For example, the system may be able to receive height input based on taking a picture using a user interface (e.g., via a smartphone camera). For example, the system may process a picture taken via a user interface (e.g., a smartphone or other computing device) using a system application and may provide an estimated user height based on templates and/or other predetermined information that may be provided via one or more exemplary system modules or features and/or an exemplary user interface.

At step 425, the system may provide a results overview (e.g., interim results overview) for review by a user. At step 430, the exemplary system may prompt a user with one or more personality test questions. The personality test may be based on any suitable psychological and/or holistic theories, research, and/or studies. For example, exemplary test questions may include providing images and prompting a user to answer how a given image makes the user feel, what color or object of a given image stands out to a user most, what does a user see in a given image, and/or what word would describe a given image. The exemplary questions may be open-ended and/or multiple choice and may be designed to provide results as described for example below.

At step 435, the system may provide results as output to the user. For example, the results may include a personality type, an astrological sign, results of numerology analysis, a sun sign, an ascendant sign, a natal chart (e.g., a map showing positions of a planet at the time a user was born), and/or any other suitable results based on personal information provided to the system. Also for example, the system may provide additional information further describing the exemplary results (e.g., meaning of a natal chart, supporting information regarding personality type, and/or any other supporting information that may help to explain the results).

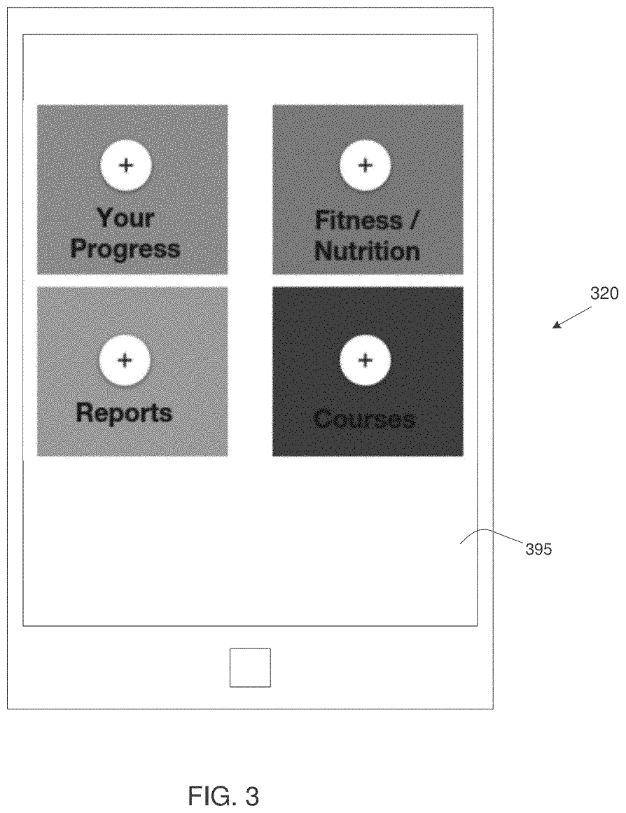

At step 440, the exemplary system may generate a user homepage (e.g., as illustrated in FIG. 3). The homepage may for example be customized to a given user based on the exemplary user input and resulting system output as described for example above. For example, the exemplary user homepage may include elements providing data regarding a user's progress (e.g., completion of stages, steps, and/or goals in a customized user plan), fitness and nutrition, reports related to user progress, educational course content, and/or any other suitable features of the exemplary system. Process 900 may end at step 445.

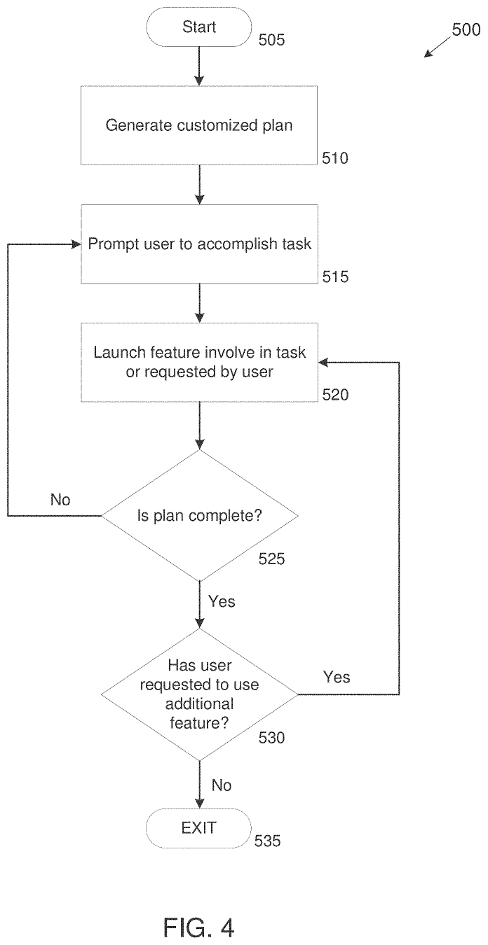

Another exemplary operation of the exemplary disclosed system and method will now be described. For example, FIG. 4 illustrates an exemplary process 500 for prompting a user to complete tasks (e.g., stages, steps, and/or goals) of a customized user plan (e.g., a user-specific plan). Process 500 starts at step 505. At step 510, the exemplary system may generate a user-customized plan based on for example artificial intelligence processes as described herein (e.g., based on analyzing user input as described for example herein). The exemplary customized plan may be uniquely customized to a given user as described for example herein. For example, a given customized plan may include tasks (e.g., stages, steps, and/or goals) generated by the exemplary system to achieve a goal desired by the user in a sequenced (e.g., step-by-step) manner.

At step 515, the exemplary system may prompt a user to perform a given task (e.g., a next stage, step, or goal in achieving an overall goal that is the purpose of the customized plan as described for example herein). At step 520, the system may launch a feature that may be involved in performing the task of step 515. For example, exemplary features described above for participating in educational courses, tracking fitness, tracking nutrition, using geo-location, using a cryptocurrency such as an alt-coin, using stored identification, using a plan status checker, and/or any other suitable feature may be launched automatically for use by a user.

At step 525, the exemplary system may determine whether or not a given customized user plan is complete. If the plan is not complete, the system may return to step 515. Additional steps 520 may be completed as described above. If the plan is complete, the system may proceed to step 530 to determine whether a user would like to launch a given feature independently of the progress toward completing the customized plan. For example the system may proceed to step 520 if the user would like to use one or more exemplary features described above. It is also contemplated that a user may use any desired feature of the exemplary system at any time based on entering input into the system. Process 500 may stop at step 535.

In at least some exemplary embodiments, the exemplary disclosed method may include prompting a user to provide input data that includes biographical information and at least one user goal, using artificial intelligence to analyze the input data, providing output data via the user interface based on using artificial intelligence to analyze the input data, and sensing location data of a user. The output data may include a user-specific customized plan. The user-specific customized plan may include a plurality of sequenced tasks. Completion of the plurality of sequenced tasks by the user may result in completion of the at least one user goal. The exemplary disclosed method may further include using the location data of the user to determine whether or not at least one task of the plurality of sequenced tasks is complete. The at least one task may be participation in an educational class. The exemplary disclosed method may further include using the location data to determine whether or not to provide a system reward to the user. The exemplary disclosed method may further include using the location data to provide law change data to the user.

The exemplary disclosed system and method may provide a simple and effective system and method for achieving personal, professional, social, spiritual, education, and/or any other desired goals. The exemplary disclosed system and method may assist a user in achieving goals by providing a customized plan having step-by-step tasks that may be completed by the user and tracked by the system. The exemplary disclosed system and method may provide feedback and information to users to achieve goals. The exemplary disclosed system and method may also provide educational resources and recommendations for activities that may support goal completion.

An illustrative representation of a computing device appropriate for use with embodiments of the system of the present disclosure is shown in FIG. 5. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 6, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 6, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 6, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

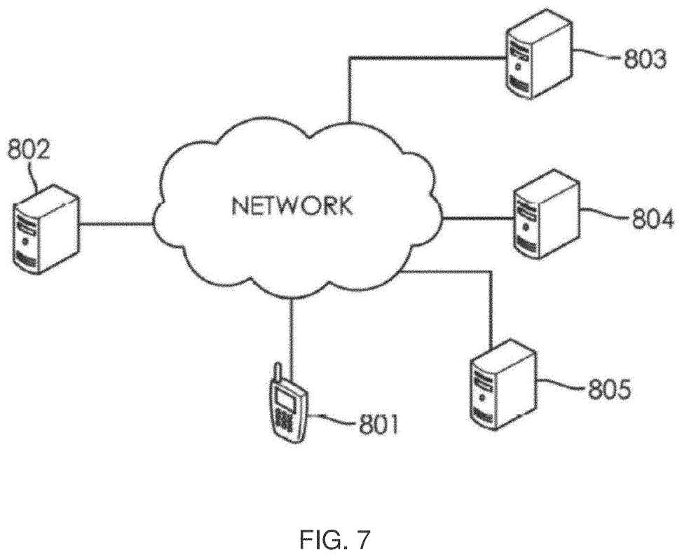

Turning now to FIG. 7, a continued schematic overview of a cloud-based system in accordance with an embodiment of the present invention is shown. In FIG. 5, the cloud-based system is shown as it may interact with users and other third party networks or APIs. For instance, a user of a mobile device 801 may be able to connect to application server 802. Application server 802 may be able to enhance or otherwise provide additional services to the user by requesting and receiving information from one or more of an external content provider API/website or other third party system 803, a constituent data service 804, one or more additional data services 805 or any combination thereof. Additionally, application server 802 may be able to enhance or otherwise provide additional services to an external content provider API/website or other third party system 803, a constituent data service 804, one or more additional data services 805 by providing information to those entities that is stored on a database that is connected to the application server 802. One of ordinary skill in the art would appreciate how accessing one or more third-party systems could augment the ability of the system described herein, and embodiments of the present invention are contemplated for use with any third-party system.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A personalized planning system, comprising:
a personalized planning module, comprising computer-executable code stored in non-volatile memory;
a processor; and
a user interface;
wherein the personalized planning module, the processor, and the user interface are configured to:
prompt a user to provide input data that includes biographical information and at least one user goal;
use artificial intelligence to analyze the input data; and
provide output data via the user interface based on using artificial intelligence to analyze the input data;
wherein the output data includes a user-specific customized plan;
wherein the user-specific customized plan includes a plurality of tasks; and
wherein completion of the plurality of tasks by a user results in completion of the at least one user goal.

2. The personalized planning system of claim 1, wherein the user interface includes a location sensor.

3. The personalized planning system of claim 2, wherein providing output data includes using location data sensed by the location sensor to provide output data selected from the group consisting of legal information of a jurisdiction, dining location and menu information, and directions to one or more locations.

4. The personalized planning system of claim 1, wherein the plurality of tasks is a plurality of sequenced tasks.

5. The personalized planning system of claim 1, wherein using artificial intelligence to analyze the input data includes identifying keywords in the input data.

6. The personalized planning system of claim 1, wherein using artificial intelligence to analyze the input data includes learning actions and behaviors of system users.

7. The personalized planning system of claim 6, wherein learning actions and behaviors of system users includes learning aggregate behaviors of sets of users.

8. The personalized planning system of claim 1, wherein the personalized planning module, the processor, and the user interface are configured to output data via the user interface of which of the plurality of tasks is complete and which of the plurality of tasks is incomplete.

9. The personalized planning system of claim 8, wherein outputting data via the user interface of which of the plurality of tasks is complete and which of the plurality of tasks is incomplete includes using location data provided by the user interface.

10. The personalized planning system of claim 1, wherein the personalized planning module, the processor, and the user interface are configured to output data via the user interface including information selected from the group consisting of a user fitness status, a user nutritional status, educational course information, and personal identification information.

11. The personalized planning system of claim 1, wherein the input data and the output data include cryptocurrency data.

12. A method, comprising:
prompting a user to provide input data that includes biographical information and at least one user goal;
using artificial intelligence to analyze the input data;
providing output data via the user interface based on using artificial intelligence to analyze the input data; and
sensing location data of a user;
wherein the output data includes a user-specific customized plan;
wherein the user-specific customized plan includes a plurality of sequenced tasks; and
wherein completion of the plurality of sequenced tasks by the user results in completion of the at least one user goal.

13. The method of claim 12, further comprising using the location data of the user to determine whether or not at least one task of the plurality of sequenced tasks is complete.

14. The method of claim 13, wherein the at least one task is participation in an educational class.

15. The method of claim 12, further comprising using the location data to determine whether or not to provide a system reward to the user.

16. The method of claim 12, further comprising using the location data to provide law change data to the user.

17. A personalized planning system, comprising:
a personalized planning module, comprising computer-executable code stored in non-volatile memory;
a processor; and
a location sensor;
wherein the personalized planning module, the processor, and the location sensor are configured to:
prompt a user to provide input data that includes biographical information and at least one user goal;
use artificial intelligence to analyze the input data; and
provide output data via the user interface based on using artificial intelligence to analyze the input data;
wherein the output data includes a user-specific customized plan;
wherein the user-specific customized plan includes a plurality of sequenced tasks;
wherein completion of the plurality of sequenced tasks by a user results in completion of the at least one user goal; and
wherein the completion of at least one of the plurality of sequenced tasks is confirmed using a sensed location of the user based on data sensed by the location sensor.

18. The personalized planning system of claim 17, wherein the personalized planning module, the processor, and the location sensor are configured to output user fitness status data via the user interface.

19. The personalized planning system of claim 18, further comprising a biometric sensor that senses biometric data, wherein the user fitness status data is based on the biometric data.

20. The personalized planning system of claim 17, further comprising a sign-in device selected from the group consisting of a near field communication device and a barcode scanning device.
